(19) United States
(12) Patent Application Publication
(10) Pub. No.: US 2007/0033641 A1
(43) Pub. Date: Feb. 8, 2007

(54) Distributed Network Security System

(75) Inventor: Jing-Long Chu, Milpitas, CA (US)

Correspondence Address: WPAT, PC;INTELLECTUAL PROPERTY ATTORNEYS, 2030 MAIN STREET, SUITE 1300, IRVINE, CA, 92614, US

(73) Assignee: ACENET TECHNOLOGY INC., Santa Clara, CA (US)

(21) Appl. No.: 11/456,186

(22) Filed: Jul. 7, 2006

Related U.S. Application Data
(60) Provisional application No. 60/696,821, filed on Jul. 7, 2005.

(51) Int. Cl. G06F 17/30

(52) U.S. Cl. 726/6

(57) ABSTRACT

The present invention discloses a distributed network security system. At least one probe unit is distributed in links before at least one end-node within a network, the probe units are adapted to provide a plurality of network securities and/or management means for the network and a plurality of management units couples to the network, the plurality of management units are adapted to manage the probe units, wherein the plurality of management units includes a central master unit and a plurality of boss units. The plurality of network and management measures can be directly applied to specific end-nodes, such as communication policing, content filtering and monitoring. These probe units are configured through a central master unit and each of the probe units may have different configurations according to the demand of network administrators. Information collected by the probe units are transferred back to the central master unit and/or boss units for further analysis to provide network administrators valuable information that supports to manage the network. Additionally, one or more management units with lower priority than the central master unit are adapted to manage a predetermined group of the probe units such that a plurality of different groups of probe units are possible to coexist and managed in the network.

### FIELD OF THE INVENTION

The present invention generally relates to a distributed network security system and, more particularly, to at least one probe unit distributing in links before at least one end-node within a network for providing complete protection.

### BACKGROUND OF THE INVENTION

Advances in communication technology and the availability of powerful desktop computer hardware have increased the use of computers to access a variety of publicly available networks. As known, the network can be a public network. For example, Internet is one of public networks that data packets are passed between users without a certain security consideration. Therefore, to make more security, organizations may concern various networks having better security means. An intranet is a corporate local area network (LAN) or wide area network (WAN) that bases Internet technology and is secured behind a controlling of centralization. The intranet may link various servers, databases, application programs, and servers like enterprise resource planning (ERP). Although intranets are developed on the same transmission control protocol/internet protocol (TCP/IP) as the Internet, intranets operate as a private network with limited access. Only authorized employees/staffs are able to access. Intranets are limited to information relation to the corporation and contain exclusive and always proprietary and sensitive information.

Network administrators responsible for the operation of private networks employ a variety of security measures to protect the network from external security breaches by unauthorized users. One well-known technique uses so-called “firewalls”, which can be implemented in both hardware and software, or a combination of both. Generally, firewalls can be established in a device as controlling of centralization that implements network protections from authorized outside access; the intranet can be used to enhance the communication security among authorized employees, managers, and other partners. Referring to FIG. 1, a conventional firewall is a device that can be coupled in-line between a public network and a private network (e.g. intranet) for screening packets received from the public network. The firewall as showed in FIG. 1 plays a role of the gateway to protect network security. Only secured information can be allowed to pass the firewall 102 from the public network 101 (e.g. internet) for transmitting. The firewall as the controlling of centralization could achieve the first line of defense against “Denied of Service” from crackers. However, such a scheme may not be sufficient for organizations with higher security demands. For example, different sections with different security clearance in an organization may not allow sensitive information to travel from one end-point to another even inside the private network. In another word, the security is unable to give consideration to the private network if any intrusion starts from the inside.

Further, as networks continue to grow in complexity and importance, the demand to collect information about network usage and problems increase. To gain a full picture of what events are occurring on the network, a network manager collects traffic information from segments of the network. According to gathered information, appropriate actions are necessary to take by network administrators to maintain the operation of the network. Internet Engineering Task Force (IETF) provides standardized sets of information, referred to as Management Information Bases (MIBs), that network devices collect to aid network administrators in monitoring the network. Request for Comment (RFC) 1757 (RMON) and 2021 (RMON-II) standard MIBs, incorporated herein by reference, contain information collected from every packet on the network.

RMON implementations are generally delivered as a two-part client/server solution. The “client” is the application that runs on the network management station and presents the RMON information to the user. The “servers” are the monitoring devices distributed throughout the remote networks that collect the RMON information and analyze network packets. The monitoring device is commonly called a “probe,” and it runs a software program, generally called an RMON “agent.” RMON agents can be found in dedicated devices and/or embedded in network infrastructure devices such as hubs and switches. The application and the agent communicate across the network using the Simple Network Management Protocol (SNMP). RMON is designed so that the remote probe devices do the data collection and processing. This reduces the SNMP traffic on the network and the processing load on the management station. Instead of continuous polling, information is only transmitted to the management station when required. Many RMON “client” applications located in various parts of the network can simultaneously communicate with and get information from one RMON “server.” The information from a single RMON server can be used for many tasks, from troubleshooting and protocol analysis to performance monitoring and capacity planning. RMON provides valuable statistics on the whole network segment. However, in actual practices, RMON servers are quite expensive equipments that not every organization or even home user can affordable. Further more, RMON “probes” embedded in hubs, switches, routers or any other centralized networking equipment may very possible consume a substantial amount of communication bandwidth.

Accordingly, it is desirable to provide a distributed network security system capable of providing higher security and better network management for network administrators through a plurality of network security measures and management applying on the end-nodes of a computer network.

### SUMMARY OF THE INVENTION

Briefly, first aspect of the present invention, a primary object of the present invention is to provide a distributed network security system to give security measures to protect different end-node to end-node communication in a network.

Another object of the present invention is to provide non-invasive probes (note: non-invasive which means non spywares) to gather information and data of end-nodes in a network for monitoring and management in order to prevent internal intrusion by malicious actions.

Thus, the distributed network security system in accordance with the present invention has the following advantages. Since probe units are deployed before each of the end-nodes in a network, a plurality of network securities and/or management means can be directly applied to specific end-nodes, such as management policing (e.g. management parameters), content filtering (e.g. uniform resource locator blocking, URL blocking), monitoring, responding, recording, etc. These probe units are configured through a center master unit and each of the probe units can have different configurations according to the requirement established by network administrators. All information and data collected by the probe units are transferred back to the center master unit for further analysis in order to provide network administrators with valuable information that supports to manage entire network. In addition, at least one management unit plays the role with lower priority than the central master unit is adapted to manage a predetermined group of the probe units that a plurality of different groups of probe units is possible to coexist and managed in the network.

### BRIEF DESCRIPTION OF THE DRAWINGS

FIG. 1 is a schematic view of a conventional local area network structure;

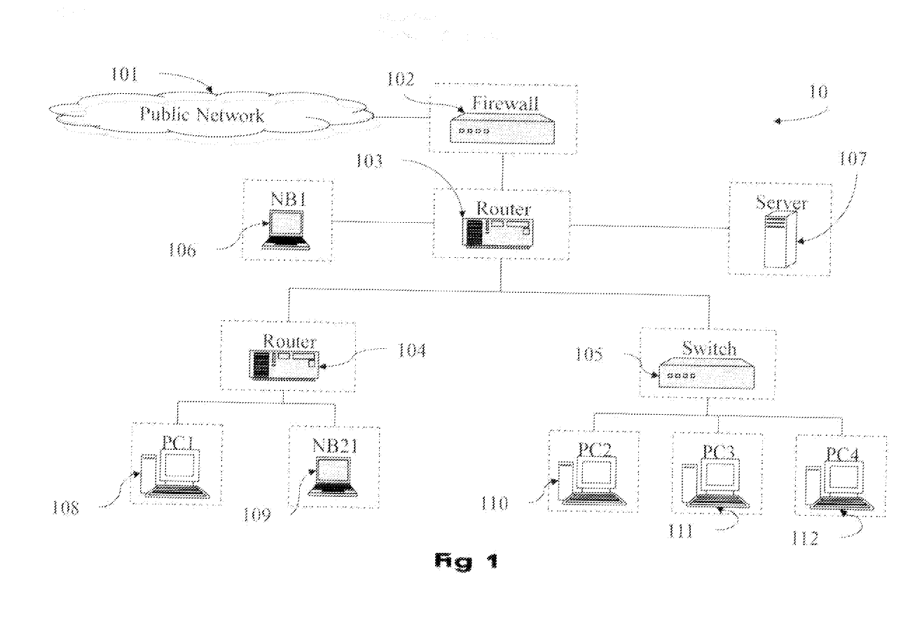

FIG. 2 shows a schematic view with deployed probe units of a preferred embodiment according to the principles of the present invention; and

FIG. 3 shows a block diagram of a probe unit of a preferred embodiment according to the principles of the present invention.

### DETAILED DESCRIPTION OF THE PREFERRED EMBODIMENTS

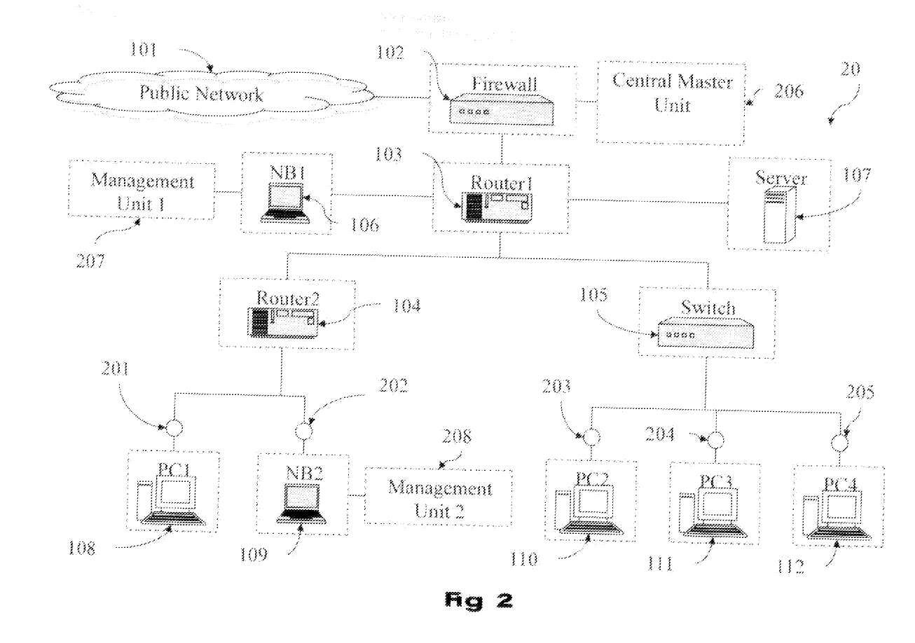

Referring to FIG. 2, an embodiment of the present invention of a distributed network security system 20, comprises:

One or more probe units 201, 202, 203, 204, 205 connecting in links before one or more end-nodes 108, 109, 110, 111, 112 to be managed in a network, the probe units 201, 202, 203, 204, 205 are adapted to provide a plurality of network security and management means for the end nodes 108, 109, 110, 111, 112. Each of the probe units can distribute in links of servers and/or routers within the network. Intruders may not become aware of these probe units. The probe unit is implemented as a piece of hardware i.e. an Application Specific Integrated Circuit (ASIC) chipset.

A central master unit 206 coupling to the network, the central master unit 206 is adapted to manage the probe units 201, 202, 203, 204, 205, i.e. sending commands to and receiving data from the probe units 201, 202, 203, 204, 205. In this embodiment, the central master unit 206 is implemented by an application program running on a separate workstation 102 that is connected to the network and which provides a user interface through which the network manager can obtain information on network traffic and performance and troubleshoot network problems. The central master unit 206, which includes a large internal memory and external storage (e.g. disks), retrieves and analyzes data that is collected by the probe units distributed throughout the network and stores the results in external storage. The central master unit 206 includes a report generator which is typically in the form of applications software which enables the network manager to analyze the retrieved data, and generate and display various user-definable performance and utilization reports. Generally, the report generator is capable of putting out a wide variety of different kinds of information and in different forms. The reported information can range anywhere from raw data (i.e., source/designation/protocol type/bytes/etc.) to the more common forms which are reports (e.g. pie charts, scatter grams, histories, etc.). In this embodiment, there is a GUI associated with the reporting package which allows the user to tailor the report that is to be generated. For example, the network manager can ask the system to identify all of the servers that a particular end-node is talking to: to identify all of the traffic between two identified end-nodes, to identify the protocols that are being used over a particular line; etc. The central master unit 206 periodically (e.g. every 10 minutes) polls the probe units for collected data. This retrieved data from the probe units is stored in a database in external storage as records, each one associated with conversations between a particular source-destination node pair.

A plurality of management units 207, 208 are boss units and couple to the network, the management units 207, 208 are adapted to manage a predetermined group of the probe units. The group of probe units can be assigned by the central master unit 206. The management units are capable of performing all the function of the central master unit 206 except for assigning probe units to other management units. The authority of the management units 207, 208 can be overridden by the central master unit 206. In actual practices, it is preferable that the network management unit 207, 208 are mere able to view the reports generated by the central master unit 206 or by the probe units. In this embodiment, the network management unit is implemented by an application program running on a separate computer that is connected to the network and which provides a web-based graphical user interface, and through the interface, network managers can obtain information on network traffic and performance and troubleshoot network problems.

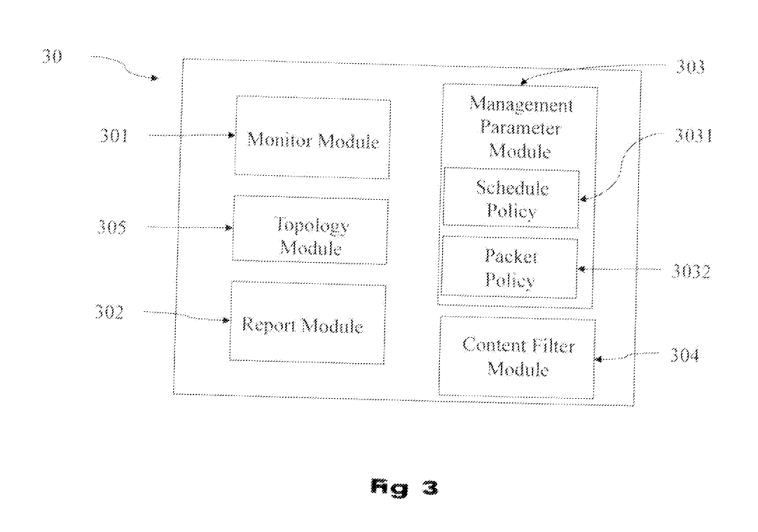

Referring to FIG. 3, each of the probe unit 30 may comprise the following modules to provide said network security and management means:

i. A monitor module:
A monitor module 301 is adapted to monitor a set of predetermined types of information of communication traffic where the probe unit 30 is connected. Referring to FIG 2, if PC1 108 talks to PC3 111, then probe units 201, 204 will see that conversation and will record the number of packets that it sees. Thus, in both of the database (not shown) of probe units 201, 204, there will be a record of the conversation between PC1 108 and PC3 111 including, for example, the number of packets sent, the time, and the identities (e.g. addresses) of the source node and destination node, the protocol, the type of protocol, the application, packet sampling etc.

ii. A report module:
A report module 302 is adapted to generate report packets and transfer the report packets back to the central master unit 206 and the management units 207, 208. In this embodiment, the report module 302 generates mainly report packets according to the information and data gathered by the monitor module and transfer the report packets to the central master unit 206 and the management units 207, 208. Simple network Management Protocol (SNMP) may be applied to implement such mechanism. Other function modules of the probe unit 30 may use the report module 302 to generate corresponding information such as log, statistics, etc., and transfer back to the central master unit 206 and/or the management units 207, 208.

iii. A management parameter module:
A management parameter 303 is adapted to block or allow or even control the bandwidth of communication traffic according to a set of predetermined parameters (e.g. policies and/or rules) in order to prevent unauthorized outside access to a network. A rule is a control policy for filtering incoming and outgoing packets. The predetermined parameters may include:
   1. A schedule policy module 3031: A schedule policy module 3031 is adapted to allow and/or block or shape the communication traffic where the probe unit is connected according to a predetermine time schedule. For example, the policy module of probe unit 201 connected before PC1 108 can be set to block communication traffic every weekend. PC1 108 will not be able to access to the network every weekend in order to avoid unnecessary risks when network managers are also in holidays. Only in certain periods of time can be allowed to access the network so as to manage the network by administrators.
   2. A packet policy module 3032: A packet policy module 3032 is adapted to allow or block packets according to a set of rules specify actions to be applied as against certain packets. When a packet is received for processing through a rule search, the packet's IP header, TCP header, or UDP header may require inspecting. A rule will generally include, at a minimum, source/destination IP addresses, UDP/TCP source/destination ports and transport layer protocol. Additional criteria may be used by the rules as well. Generally, the address information is used as matching criterion—in other words to match a rule, a packet must have come from a defined source IP address and its destination must be the defined destination IP address. The UDP/TCP source/destination port specifies what client or server process the packet originates from on the source machine. The packet policy module 3032 can be configured to permit or deny a packet based upon these port numbers. The rule may include a range of values or a specific value for a TCP/UDP port. The transport layer protocol specifies which protocol above the IP layer, such as TCP or UDP, the policy rule is to be enforced against. The packet policy module 3032 described above essentially screens packets using an access control list (ACL), and may be referred to as an ACL engine. That is, it performs a simple comparison of various matching criteria of an incoming IP packet—typically source, destination, port and protocol—to each rule in a rule set in sequence. Based upon this comparison, an incoming IP packet is either allowed or denied.

iv. A content filter module:
A content filter module 304 is also called URL blocking that is adapted to analyze and insulate packets according to their content in order to prevent unauthorized outside access to a network. Corporations may wish to allow their employees to access technical or business sites but not entertainment oriented sites. By restricting within particular types of content, employees can increase productivity to conserve bandwidth resources. In this embodiment of the present invention, the content filter module 304 provides orient-based filtering measures, i.e., word-screening or phrase-screening, which prevents access to any WAN or LAN resources which contain any word or phrase on a predetermined list.

v. A network topology module:
A network topology module 305 is adapted to collect topology information and to transfer collected information back to the central master unit 206 for further analysis, such that the central master unit 206 further processes the stored records within the database to create a “view” of the network. This view of the network constitutes a representation of the actual map of the network, identifying where the nodes are located in terms of the identity of the probe units. The view is also referred to as a physical group list. It consists of a list for each probe unit and each list identifies the end-nodes that appear to be connected to that probe unit. In accordance with principles this present invention, the probe units are connected in links before each end-nodes, as a result, it is relatively much easier than the conventional approach to decide closest to which end-node is a probe unit located. And thus can easily discover the topology of a computer network.

While the present invention has been described with reference to certain preferred embodiments, those skilled in the art will recognize that various modifications may be provided. Variations upon and modifications to the preferred embodiments are provided for by the present invention, which is limited only by the following claims.

What is claimed is:

1. A distributed network security system, comprising:
at least one probe unit distributed in links before at least one end-node within a network, the probe units adapted to provide a plurality of network securities and/or management means for the network; and
a plurality of management units coupling to the network, the plurality of management units adapted to manage the probe units, wherein the plurality of management units includes a central master unit and a plurality of boss units.

2. The distributed network security system of claim 1, wherein each of the probe units can distribute in links of servers and/or routers within the network.

3. The distributed network security system of claim 1, wherein each of the probe units includes a monitor module for monitoring communication traffic.

4. The distributed network security system of claim 3, wherein the monitor module monitors a predetermination of information, and the predetermination of information includes the number of packets sent, the number of packets received, the identities of the source node, the identities of the destination node, the protocols, the protocol types, the application, the contents and the packet sampling.

5. The distributed network security system of claim 3, wherein the monitor module samples packets at a predetermined period of time.

6. The distributed network security system of claim 1, wherein each of the probe units further includes a report module, the report module is adapted to generate report packets and transmits the report packets back to the center master unit of the plurality of management units.

7. The distributed network security system of claim 1, wherein each of the probe units includes a management parameter module, the management parameter module is adapted to permit, deny or control bandwidth of the communication traffic according to predetermined management parameters in order to prevent unauthorized access to the network.

8. The distributed network security system of claim 7, wherein the predetermined management parameters corresponds to an access control list (ACL).

9. The distributed network security system of claim 1, wherein each of the probe units includes a content filter module, the content filter module is adapted to analyze and isolate packets according to content characteristics in order to prevent unauthorized access to the network.

10. The distributed network security system of claim 1, wherein each of the probe units includes a network topology module, the network topology module is adapted to collect topology information for further analyzing.

11. The distributed network security system of claim 1, wherein each of the probe units is implemented with an Application Specific Integrated Circuit (ASIC) chipset.

12. The distributed network security system of claim 1, wherein the central mask unit is implemented with an application program that executes on a separate workstation.

13. The distributed network security system of claim 1, wherein the central mask unit provides a web-based graphic user interface (GUI) to manage the network.

14. The distributed network security system of claim 1, further comprising at least one management unit coupling to the network, wherein the management units are adapted to manage a predetermined group of probe units.

15. The distributed network security system of claim 14, wherein each of the management units is implemented with an application program running on a separate computer.

16. The distributed network security system of claim 14, wherein each of the management units usually has lower priority than the center master unit that the center master is able to override communards made by each of the management units.

17. The distributed network security system of claim 14, wherein each of the management units provides a web-based GUI for managing the network.

18. The distributed network security system of claim 14, wherein the central unit and boss units can be deploy in anywhere of the end nodes.

19. The central master unit and a boss unit could be together in one system.

20. The probe units can be deployed in anywhere of the network link.
